(19) United States
(12) Patent Application Publication
(10) Pub. No.: US 2008/0285780 A1
(43) Pub. Date: Nov. 20, 2008

(54) Method to Adjust a Hearing Aid Device, Hearing Aid System and Hearing Aid Device

(75) Inventor: Ronaldus Maria Aarts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/092,282

(22) PCT Filed: Oct. 26, 2006
(86) PCT No.: PCT/IB06/53938

§ 371 Date: May 1, 2008

(30) Foreign Application Priority Data
Nov. 1, 2005 (EP) 05110239.0

(51) Int. Cl. H04R 25/00

(52) U.S. Cl. 381/312

(57) ABSTRACT

Method to adjust a hearing aid device, the method comprising: —generating one or more acoustic signals (S2) to induce otoacoustic emissions (OAE) in an inner ear (UIE) of a user of the device (1; 101; 201); —measuring the otoacoustic emissions (OAE); and —adjusting the hearing air device (1; 101; 201) based on a result from the measurement of the otoacoustic emissions (OAE), wherein the inducing and/or measuring of the otoacoustic emissions is at least partly carried out by the hearing aid device (1; 101; 201).

The invention relates to a method to adjust a hearing aid device. The invention also relates to a hearing aid system and a hearing aid device.

Hearing aid devices are known from the prior art. Generally, the known hearing aid device can detect sounds, originating from an environment of a user. The known hearing aid device can amplify the detected sounds, and feed the amplified sounds to the ear of the user. In this way, the hearing aid device can at least partly compensate for a hearing loss of the user. Various types of hearing devices are known, for example devices that can be positioned substantially in part of the ear canal of a user, devices that are positioned in or on the outer ear of the user, or other types of hearing aid devices. For example, one ear or both ears of the user can be provided with a suitable hearing device.

Usually, gain parameters of the hearing aid device have to be adjusted, based on the hearing loss of the respective ear (or ears) of the user. Traditionally, such an adjustment is carried out in a clinic by an audiologist. This can be a tedious procedure, especially for mental handicapped patients, or for very young children. Knowing the hearing loss, the audiologist can adapt the gain of the hearing aid device.

The present invention aims to solve, or at least alleviate the above-mentioned problems. Particularly, the present invention aims to provide a method in which the hearing aid device can be adjusted in a simple manner. Also, the present invention aims to provide a user-friendly hearing aid system.

According to an aspect of the invention, a method to adjust a hearing aid device comprises:
generating one or more acoustic signals to induce otoacoustic emissions in an inner ear of a user of the device;
measuring the otoacoustic emissions; and
adjusting the hearing air device based on a result from the measurement of the otoacoustic emissions, wherein the inducing and/or measuring of the otoacoustic emissions is at least partly carried out by the hearing aid device.

In this way, a hearing loss of an ear of the user can be detected in a simple manner, for example by and/or under the control of the hearing aid device. Also, for example, the hearing aid device can be adjusted, without the need or help of a doctor.

For a large number of users of hearing aid devices, otoacoustic emissions can provide a good indication of the hearing loss of their ear(s). Otoacoustic emissions of an inner ear as such are well known in the art and have been discovered a long time ago, see for example the article “A review of otoacoustic emissions” of R. Probst et al., J. Acoustic. Soc. Am., Vol 89, No. 5, pp 2027-2067, May 1991. Until the present invention, no one came up with the simple idea, to make use of otoacoustic emissions in adjusting a hearing aid device, wherein the inducing and/or measuring of the otoacoustic emissions is carried out by the hearing aid device. Also, in this way, a very user-friendly hearing aid system can be provided.

Further, in an aspect of the invention, there is provided a method to detect at least one property of a user of a hearing aid device, wherein the hearing aid device detects the at least one property of the user. For example, the hearing aid device can generate a message in case the detected property reaches a predetermined threshold value of that property.

The property of the user can be, for example, a hearing loss. In that case, advantageously, the hearing loss is being detected using otoacoustic emissions of the inner ear. Besides, for example, the property can be a temperature of the user, for example to detect fever or an other user condition, or a different user property.

Also, an aspect of the invention provides a computer program product, comprising computer code, configured to carry out a method according to the invention when the code is being loaded in and/or carried out by a control part of a hearing aid system.

An aspect of the invention provides a hearing aid system, for example configured to carry out a method according to the invention, the system including a hearing aid device configured to be worn by a user, wherein the hearing aid device is configured to carry out measurements of otoacoustic emissions which can emanate from at least one inner ear of the user during use.

This system can provide above-mentioned advantages. The system can be relatively user friendly. For example, preferably, the system is operated without the assistance of a doctor, wherein a certain hearing loss of the user can be at least partly compensated in a simple manner.

Besides, an aspect of the invention provides a hearing aid device, configured to detect a temperature of a user of the device.

This hearing aid device can be advantageously used, for example, by mental handicapped patients, and/or very young children, or different users. The hearing aid device can not only aid the user in hearing sounds, but also monitor a temperature of the user, for example to detect a physical condition of the user.

Further advantageous embodiments of the invention are described in the dependent claims.

The invention will now be described in more detail on the basis of exemplary embodiments shown in the accompanying drawing, wherein:

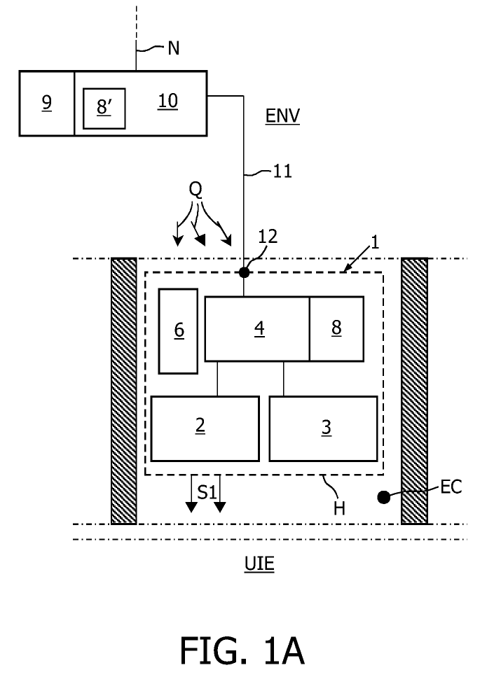

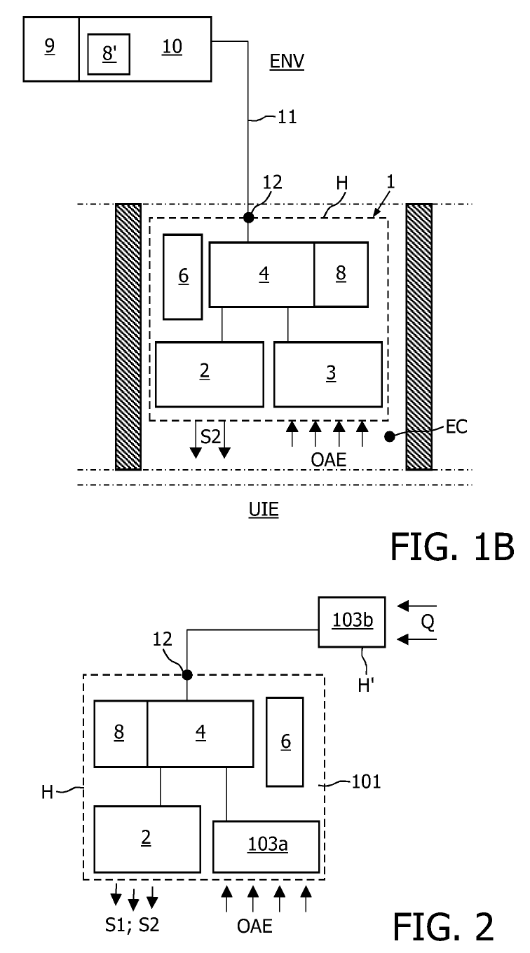

FIG. 1A schematically depicts a first embodiment of the invention, in a first mode of operation;

FIG. 1B schematically depicts the first embodiment in a second mode of operation;

FIG. 2 schematically depicts a second embodiment of the invention;

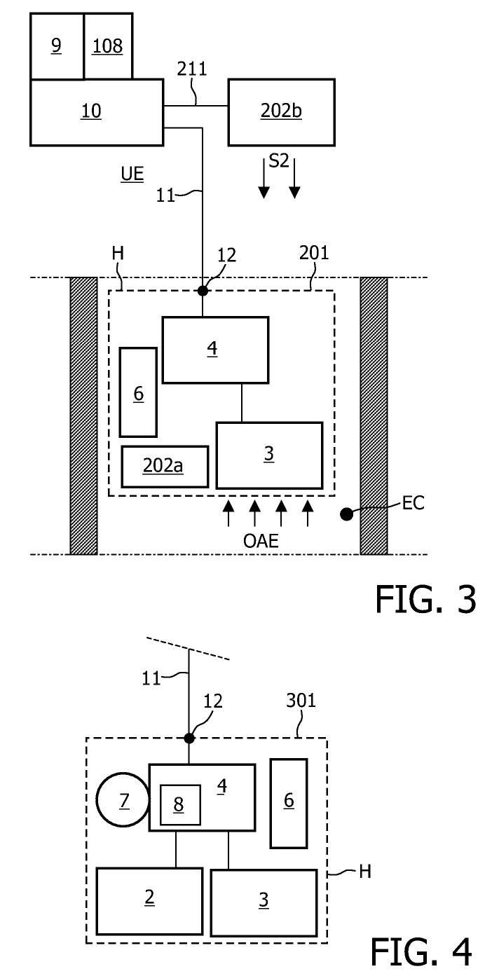

FIG. 3 schematically depicts a third embodiment of the invention; and

FIG. 4 schematically depicts a fourth embodiment of the invention.

In the present application, similar or corresponding features are indicated by similar or corresponding reference signs.

FIG. 1 schematically depicts a first embodiment of a hearing aid system. Particularly, FIG. 1A depicts a first mode of operation, and FIG. 1B a second mode of operation of the system. The system is provided with a hearing aid device 1, configured to be worn by a user. The hearing aid device 1 can be configured in various ways. For example, the hearing aid device 1 can be configured to be located in an ear canal EC of a user, in an outer ear of the user, and/or externally with respect to the user. In the present embodiment, the hearing aid device 1, particularly a housing H thereof, can be placed substantially within the ear canal EC. Preferably, the hearing aid device 1 is a portable lightweight device 1.

In an aspect of the invention, the system can operate at least in a first or hearing aid mode, shown in FIG. 1A, in which mode the hearing aid device 1 can amplify ‘outside’ sounds Q emanating from an environment ENV of the user. To this aim, the hearing aid system of the first embodiment can be provided with one or more sound detectors 3 to detect sound, with one or more sound generators to generate at least partly amplified sound S1, and with a suitable control 4, 10. The control 4, 10, sound detector(s) and sound generator(s) 2 can be configured to at least partially amplify the sounds Q emanating from an environment of the user.

For example, a sound detector 3 of the system can be configured to detect sounds (indicated by arrows Q) originating from an environment ENV of the user. The control 4, 10 can be coupled to the sound detector 3 to receive sound detection signals, relating to detected sounds Q, there-from. The control 4, 10 can at least partially amplify the sound detection signals. The amplification can be based on, or make use of, one or more gain parameters of the hearing aid device 1, for example a frequency dependent gain or frequency dependent gain parameters. As an example, such gain parameters can be stored in a memory 8, 8′ of the control 4, 10. For example, certain parts of the spectrum of the sounds Q can be amplified by the control 4, 10. Besides, the control 4, 10 can be configured to carry out certain adjustments to the sounds Q (or sound detection signals) to be amplified, for example to reduce noise, to improve sound quality, to provide a certain directivity, to equalize the sounds, and/or a different type of sound processing. The control 4, 10 can be coupled to the sound generator(s) 3, to feed respective sound signals to the sound generator, to generate the at least partly amplified sounds S1. In this way, a certain hearing loss of the user can be at least partly overcome or counteracted by the hearing aid system.

For example, in the present embodiment, the hearing aid device 1 is provided with a suitable sound detector 3, a suitable sound generator 2 and at least a first part of a mentioned control 4 (see FIG. 1A). The control part 4 of the hearing aid device 1 can be provided, for example, with a mentioned memory 8, for example to store mentioned gain parameters and/or other data or information. As an example, the hearing aid device 1 can include a suitable housing H (depicted by broken lines H in the figures), which housing H can be provided with a mentioned sound detector 3, sound generator 2 and/or control part 4. As an example, such a housing H can be relatively compact, and may be formed to fit at least partially in the ear canal EC of the user, to be inserted therein.

Alternatively, one or more parts of the hearing aid device 1 can be mountable to the outer ear of the user, or on other locations with respect to a head of the user. For example, the device 1 can comprises several housings, for example a first housing part H that can be inserted into the ear canal EC and a second housing part H′ that is to be located externally with respect to the ear canal EC. For example, in that case, the first housing part can include the sound generator 2, and the second housing part H′ can include one or more of the sound detectors 103b (see for example FIG. 2).

Each sound detector 3 can be configured in various ways. For example, the sound detector can comprise a suitable microphone, a sensitive low-noise microphone, transducer or different detector. Also, each sound generator 2 can be configured in various ways, and can comprise for example a loudspeaker, transducer, receiver, or different sound generator.

The control 4, 10 can comprise, for example, suitable hardware, micro-electronics, software, one or more processors, digital signal processing means, one or more memories 8, 8′ and/or other suitable means to control and/or carry out the amplification of sound signals, as well as to control and/or carry out the adjusting of the hearing aid device 1 as will be described below. The control can be at least partly be provided by a computer program product, comprising computer code, configured to carry out a respective method when the code is being loaded in and/or carried out by a respective control part 4, 10 of the system.

Besides, for example, part of the control 4 can be a local part of the hearing aid device 1, as is depicted in FIG. 1A, for example a control part that is provided in the housing H of the hearing aid device 1. Such an (internal or local) hearing aid control part 4 can be provided with a respective hearing aid device memory 8. Also, the control can comprise at least a control part 10, which is external to the hearing aid device 1. Such an external control part 10 can comprise or be part of, for instance, a docking station and/or a battery charger of the hearing aid device, or a personal computer, a personal digital assistant (PDA), or a different suitable external control part 10. Also, such an external control 10 can be provided with a respective memory 8′. For example, the external control part can be a remote control of the hearing aid device 1.

Besides, in a further embodiment, the hearing aid device 1 can include a suitable power source 6, to provide power to the control 4, sound detector 3 and sound generator 2. Such a power source 6 can be, for example, a battery, a replaceable battery, a rechargeable battery or a different power source, and can be provided in an hearing aid housing H. A mentioned docking station 10 can be configured to recharge a rechargeable power source 6 of the hearing aid device 1, in case the device 1 is docked onto a suitable docking location of such a docking station 10.

In case the system includes an external control part 10 (such as a remote control) and a local control part 4 of the hearing aid device 1, both control parts 4, 10 can be configured to communicated with each other via one or more suitable communication lines 11, 12, for example via wireless and/or wired communication means, via docking contacts, battery charging connections or via different means. A communication line 11, which can couple an external control part 10 to a communication connector 12 of a control part 4 of the hearing aid device 4, is schematically drawn in FIG. 1.

Besides, a communication network N, such as a computer network and/or telephone network, can be provided, to provide communication between a controls 4, 10 of the hearing aid system and a remote location. Such a remote location can be, for example, part of a central hearing aid clinic, a remote patient monitoring station, a location of a relative of the user of the hearing aid station, and/or a different location.

In an aspect of the invention, the system can also operate at least in a second mode, also called ‘adjustment mode’ or ‘programming mode’, in which second mode the hearing aid device 1 can be adjusted. Particularly, in that case, one or more of the gain parameters of the hearing aid device 1 can be adjusted. For example, the gain parameters can be adjusted to at least partially compensate for any (further) hearing loss of a user. The term “adjust” should be interpreted broadly; for example, this term can mean adjusting, changing, setting, raising and/or lowering one or more hearing aid parameters, such as one or more gain parameters and/or other hearing aid parameters. An example of the second (adjustment) mode is depicted in FIG. 1B. The system may switch between the first (hearing aid) mode and second (adjustment) mode in various ways, for example by user control, under timer control, automatically, or in a different way.

According to an aspect, the hearing aid device 1 is configured to carry out measurement of otoacoustic emissions OAE, which emanate from at least one user inner ear UIE of the user during use. For example, the hearing aid system can carry out and/or control such measurements when the system is in the second (adjustment) mode; in that case, the second mode can also be called a ‘detection mode’. Besides, the control 4, 10 of the hearing aid system 1 can be configured to carry out and/or to control the measurements of the otoacoustic emissions OAE.

Advantageously, one or more gain parameters of the hearing aid device 1 are simply adjustable, based on the result of the determination of the otoacoustic emissions OAE, emanating from the inner ear UIE. For example, at least one gain parameter of the hearing aid device can be adjustable to at least partly counteract of compensate for a certain hearing loss of the user, wherein the system is configured to detect the hearing loss from the results of the measurement of the otoacoustic emissions. As an example, gain parameters can be adjusted to counteract a specific hearing loss, the hearing loss being over a certain frequency band (or part of the total human hearing range), wherein that hearing loss has been detected by otoacoustic emission measurements.

In a further embodiment, the system includes at least one acoustic signal generator 2 to generate one or more acoustic signals S2 to induce otoacoustic emissions in the inner ear UIE of a user. For example, the signal generator 2 can simply be configured to be located in the ear canal EC of the user, and/or in an outer ear of the user, and/or externally with respect to the user. In the embodiment of FIG. 1A, 1B, the signal generator 2 is part of the hearing aid device 1. In that case, the hearing aid device 1 not only carries out and/or controls detection of otoacoustic emissions, but also stimulates or induces such emissions.

Particularly, in the present embodiment, the above-mentioned sound generator 2, to be used to generate the amplified sounds S1 relating to the sounds Q originating from the user environment ENV, and the present signal generator 2, to generate acoustic signals S2 to induce otoacoustic signals, are the same. Thus, a compact hearing aid device 1 can be provided, wherein the sound/signal generator 2 can provide different functions.

Also, in an aspect, the system includes at least one sound detector 3 to detect the otoacoustic emissions and/or to detect sounds emanating from an environment ENV of the user. For example, such a sound detector can be configured to provide a detection signal, which signal is dependent of detected sounds such as otoacoustic emissions. Such a detection signal can be used as a result, on which adjustment of the hearing aid device 1 can be based. Besides, such a detection signal can be processed by suitable signal processing means, to detect otoacoustic emissions from the detection signal. Moreover, such signal processing means may be configured to compare any signals, which have been detected by the sound detector 3, with acoustic signals S2 that have been generated by said signal generator 2, to detect otoacoustic emissions. As an example, such signal processing means can be part of a control 4, 10 of the hearing aid system.

Particularly, such a sound detector 3 can be configured to be located in the ear canal, in the outer ear and/or externally with respect to the outer ear of the user. In the embodiment of FIG. 1A, 1B, the sound detector 3 is part of the hearing aid device 1. Moreover, in the present embodiment, it is advantageous when the above-mentioned sound detector 3, to be used to detect sounds Q originating from the user environment ENV, and the present sound detector 3 for detecting the otoacoustic signals, is one and the same sound detector. Thus, also, a compact hearing aid device 1 can be provided, wherein the sound detector 3 can provide different functions.

In a further embodiment, the position of the sound detector 3 of the hearing aid device 1 can be adjustable between a first position, in which the sound detector 3 can detect sounds Q originating from the environment of the user, and a second position, in which second position the sound detector 3 is positioned to detect sound OAI originating from the inner ear UIE of the user. This can be achieved in various ways. For example, the position of the sound detector 3 can be adjustable with respect of the ear or a head of a user. As an example, the position of the sound detector 3 can be adjustable with respect to an other part of the hearing aid device 1, for example with respect to a housing H of the device. Besides, for example, the position of the sound detector 3 can simply be adjusted by repositioning the hearing aid device 1 with respect to the ear or head of the user. In an embodiment, the sound detector 3 is movably and/or detachably coupled to the housing H of the hearing aid device, to change the position of the detector 3 between the mentioned first and second position.

The system can be configured to generate various types of acoustic signals S2 to induce otoacoustic emissions OAE, for example one or more signals, of one or more frequencies, having a certain signal strength. For example, the system can be configured to generate short acoustic clicks, acoustic pulses and/or tone-bursts, to induce otoacoustic emissions OAE. In that case, for example, a mentioned sound generator can also be used as a sound detector, for example in case the sound generator is a suitable acoustic transducer.

Besides, the system can be configured to generate at least two simultaneous tones of different frequencies, for example nearby frequencies, to induce otoacoustic emissions OAE. Also, the system can be configured to generate at least one sustained acoustic signal of a predetermined frequency, to induce otoacoustic emissions OAE. For example, different types of signals S2 can be emitted after each other, to induce different types of otoacoustic emissions OAE. To the skilled person it will be clear, how for example the control 4, 10 and/or signal generator(s) of the system can be configured to generate a certain type of signals S2.

Also, in a further elaboration of the invention, a memory 8, 8′ of the system can be used to store results of the measurement of the otoacoustic emissions. Also, the system can include a display 9, which can be used to display a result of the measurement of the otoacoustic emissions. The display 9 can, for example, be coupled to the control 4, 10, or be part of an external part 10 of the control. As an example, the storing and/or displaying of the measurement results can be controlled by a control 4, 10 of the system.

In a further embodiment, the system, for example the control 4, 10 or part thereof, can be configured to compare the result of the measurement of the otoacoustic emissions to a predetermined hearing loss threshold value. In that case, advantageously, the system can be configured to generate a message in case the result of the measurement of the otoacoustic emissions reaches a predetermined hearing loss threshold value. Such a message can be displayed, for example on the display 9. The message can be a sound message, for example a voice message that is emitted by a sound generator 2 of the system. Besides, the message may be transmitted to a remote location, for example via the communication network N.

Also, in an embodiment, the system can be configured to detect certain obstructions of the ear canal EC, using otoacoustic emissions. For example, such obstructions can include a superfluous amount of cerumen (ear wax). The system can also be configured to generate a warning message in case a certain ear canal obstruction is detected.

During use of the embodiment of FIGS. 1A, 1B, the hearing aid system can be in a hearing aid mode (see FIG. 1A). Besides, the hearing aid device 1 can be located in a suitable hearing aid position, for example at least partly in or near the ear canal EC of the user. The sound detector 3 of the hearing aid device 1 can detect external sounds Q. The hearing aid device 1 amplifies the detected sounds Q, or parts thereof. The resulting amplified sounds S1, which can be generated by the control 4 and sound generator 2 of the device 1, are usually directed into the ear canal EC towards the ear drum of the user, to assist the user in hearing the external sounds Q.

During use, the hearing aid system can be brought into the mentioned second (adjustment) mode, for example manually or automatically. As an example, the second mode may commence automatically after the system or hearing aid device has been turned on, after a battery switch, after the hearing aid device 1 has been removed from a respective docking station 10 (if available), and/or in a different way. Also, for example, the system can automatically switch from a first to a second mode depending on a condition of the user, for example when the user is sleeping, or when a long period of inactivity of the user is detected. To this aim, for example, a control part 4 of the hearing aid device (or an other part of the hearing aid system) can be provided with a user activity detector, such as a motion detector or a different detector.

As is shown in FIG. 1B, the hearing aid device 1 can be worn by the user, in a suitable hearing aid position, when the system is in the second mode as well. After the system has entered the second mode of operation, the system can perform a method to adjust the hearing aid device. Therein, one or more acoustic signals S2 are generated to induce the otoacoustic emissions OAE in the inner ear UIE of the user. Particularly, such emissions can originate from the cochlea (or cochlea hair cells) of the inner ear UIE. The otoacoustic emissions OAC can be transmitted back, from the inner ear UIE via the middle ear towards the ear canal EC of the user.

The one or more acoustic signals S2 can be generated in various locations, for example in the ear canal EC of the user, and/or in an outer ear of the user, and/or externally with respect to the outer ear of the user.

In the present embodiment, the acoustic signals S2 can simply be generated by the sound generator 2 of the hearing aid device 1, particularly when the device 1 is worn by the user. The generation of the acoustic signals S2 can be controlled by the control 4, 10 of the system, for example by the control part 4 of the hearing aid device 1. In a further embodiment, the generation of the acoustic signals S2 can be controlled by an external control part 10. To that aim, the external control part 10 can communicate with the hearing aid control part 4 and/or sound generator 2 via the respective communication line 11.

As follows from the above, various sound signals S2 can be generated during the second mode of the system. In case the one or more acoustic signals S2 include short acoustic clicks, acoustic pulses and/or tone-bursts, particularly, so called transient otoacoustic emissions OAE may be induced. Besides, in case the one or more acoustic signals S2 include at least two simultaneous tones of different frequencies, for example nearby frequencies, particularly, so called distortion product otoacoustic emissions OAE may be induced. Also, if the one or more acoustic signals S2 include at least one sustained acoustic signal of a predetermined frequency, so called sustained-frequency otoacoustic emissions OAE may be induced.

The otoacoustic emissions OAE are detected. In the present embodiment, this measurement of these emissions can simply be carried out by the sound detector 3 of the hearing aid device 1, which sound detector 3 is located in of near the ear canal (see FIG. 1B) in the present embodiment.

After the detection of the otoacoustic emissions OAE, the hearing air device 1 can be adjusted based on results from the measurement of the otoacoustic emissions. For example, one or more of the mentioned gain parameters of the hearing aid device 1 can be adjusted, wherein the adjustment of the gain parameters is based on the result of the detection of the otoacoustic emissions OAE. Also, at least one gain parameter of the hearing aid device 1 can be adjusted to at least partly counteract a hearing loss of the user, wherein the detection of the hearing loss is based on the results of the measurement of the otoacoustic emissions.

The adjusting of the hearing aid device 1 can be automatically, and can be carried out by a control part 4, 10 of the system. Alternatively, a user of the system, or a different person, can adjust the hearing aid device 1, based on the measurement results. For example, a control part 4, 10 of the system can be arranged to be operated by a user or by a different person, to adjust hearing aid parameters of the hearing aid device 1.

Preferably, the system includes a safety mechanism, which can ensure that the gain of the hearing aid device 1 is not adjusted to a value above a certain maximum allowable gain of the hearing aid device. For example, such a maximum allowable gain can relate to user safety and/or to device specifications.

Besides, a result of the measurement of the otoacoustic emissions can be stored for example by a control part 4, 10 of the system, such as by control 4 of the hearing aid device 1 and into a memory 8 of the hearing aid device 1. In the latter case, the stored measurement results may be loaded from the hearing aid device 1, for example into an external control 10 (such as a docking station), to be evaluated and/or processed, for example to adjust the hearing aid device 1. Alternatively, the measurement results can also be stored externally of the hearing aid device, for example in a memory 8′ of an external control 10, wherein transmission of the measurement results to the external control can be provided with the communication line 11. Moreover, stored measurement results can be used, to detect variation (for example a worsening) of the hearing loss over a longer period of time.

Also, a result of the measurement of the otoacoustic emissions can be displayed, for example on the display 9. Thus, a user or operator of the system can view the results, for example to check for any (further) hearing loss of the hearing aid device user, and/or to use the results in adjusting the hearing aid device 1. Besides, results of the measurements can be sent to one or more remote locations, for example via the communication network N.

During use, the result of the measurement of the otoacoustic emissions OAE can be compared to a hearing loss threshold value of otoacoustic emissions. Such a comparison is preferably carried out automatically, for example by a control part 4, 10 of the system. Alternatively, the comparison is carried out by a person. The threshold value can be a predetermined value, and/or include a range of values, for example different values for different frequencies or frequency ranges.

Besides, during use, the result of the measurement of the otoacoustic emissions OAE can be compared to earlier results of measuring the otoacoustic emissions OAE of the user, which earlier results can be stored in a mentioned memory 8, 8′.

Also, one or more above-mentioned messages can be generated in case the result of the measurement of the otoacoustic emissions OAE reaches (or exceeds) a mentioned hearing loss threshold value, and/or in case a relatively large hearing loss is being detected compared to an earlier hearing loss determination. As an example, an alarm message can be generated on the display 9, in case a relatively large hearing loss is being detected, or in case a large change of hearing loss is detected with respect to a prior hearing loss determination. Besides, the message can be a voice message, which is emitted via the sound generator 2 of the hearing aid device 1. The message be a warning, and/or an advice that the user must consult a doctor. Also, one or more of such messages can be sent to remote locations, for example part of a central hearing aid clinic, a remote patient monitoring station, a location of a relative of the user of the hearing aid station.

Also, in an embodiment, during use, the system can be configured to detect certain unnatural or undesired obstructions of the ear canal EC, for example, to detect a superfluous amount of cerumen (ear wax), utilizing the inducing and/or detection of otoacoustic emissions. In case such an obstruction is detected, a warning message can be given, for example a message indicating that the obstruction has to be removed. For example, detection of cerumen can be carried out by comparing the result of the measurement of the otoacoustic emissions OAE to earlier results of measuring the otoacoustic emissions OAE of the user, wherein the earlier results can be stored in a mentioned memory 8, 8′.

In a further embodiment, the position of the sound detector 3 of the hearing aid device is adjusted from a first position, in which the sound detector 3 can detect sounds originating from the environment ENV of the user, to a second position, in which second position the sound detector 3 is positioned to detect sound originating from the inner ear of the user. For example, the sound detector 3 can listen into the ear canal EC when it is in the second position. Besides, the system can be configured such, that the mode of the system can be changed between the first and second mode, by adjusting the position of the sound detector between the first position and second position.

In a further embodiment, the method and system, depicted in FIGS. 1A, 1B can be combined one or more times with a traditional method to measure a patients hearing loss. In such a traditional method, a audiologists measures a hearing loss of a patient, by playing sound signals and by asking the patient whether he/she can hear the sound signals. In that case, for example, the traditional method can be used to adjust the gain parameters for a first time, where-after the above described method using otoacoustic emissions is used to periodically check the hearing loss and adjust the gain parameters if desired. Also, after a certain amount of time of using the hearing aid system, for example during a check-up at an audiologist, the traditional method can be applied again, for example to verify whether the otoacoustic emission method has adjusted the gain parameters appropriately during the use of the system.

After the adjusting of the hearing aid device 1, the system can be brought back to the first (hearing aid) mode. In that mode, the adjusted hearing aid device 1 can again provide an amplification of outside sounds Q, wherein changes in the hearing loss of the user can be taken into account via the adjusted hearing aid parameters.

FIG. 2 depicts a second embodiment. The second embodiment differs from the embodiment shown in FIGS. 1A, 1B in that the hearing aid system comprises at least a first sound detector 103a configured to detect sounds Q originating from the environment of the user, and at least a second sound detector 103b configured to detect otoacoustic emissions OAE originating from the inner ear of the user. For example, both the first and second sound detector 103a, 103b can be part of the hearing aid device 101, for example by being integrated in a housing H of the device 101. Also, one of the sound detectors can be located externally of the hearing aid device 101 (or a housing H thereof), as is depicted in FIG. 2. For example, the first sound detector 103a can be located in the ear canal EC of a user, whereas the second sound detector 103b can be located on the outer ear or pinna. Besides, the sound detectors 103a, 103b can have different ‘listening directions’, to detect the outside sounds Q and otoacoustic emissions OAE. The sound detectors 103a, 103b may be spaced-apart from each other.

The use of the second embodiment differs from the use of the first embodiment, in that the first sound detector 103a can be used to detect the sounds Q originating from the environment ENV of the user, for example when the system is in the second (adjustment) mode. The second sound detector 103b can be used to detect otoacoustic sounds originating from the inner ear UIE of the user, when the system is in the second mode. In this way, noise Q outside the ear canal EC can be decoupled from the otoacoustic emissions OAE. For example, the system can be provided with a suitable noise cancellation system, which can separate outside noise (detected for example by the second detector 103b) from a combination of noise and otoacoustic emissions OAE, which combination can be detected by the first detector 103a, depending on the positioning of the detectors 103a, 103b. Such a noise cancellation system can be, for example, part of the control 4, 10 of the system.

FIG. 3 shows yet another embodiment, which differs from the first embodiment, in that the hearing aid device 201 as such (or its housing H) comprises a sound generator 202a, to be used in the first mode of the system to generate amplified sounds. In the embodiment of FIG. 3, a second sound generator 202b is located externally with respect to housing H of the hearing aid device 1, to generate signals S2 to induce otoacoustic emissions in the inner ear UIE of the user. For example, the second signal generator 202b can be coupled to a control 4, 10 of the system, such as via a respective communication line 211, to be controlled thereby.

In the embodiment of FIG. 4, the hearing aid device 301 is configured to detect at least one property of the user of the device. For example, the hearing aid device 301 can be configured to detect a temperature of the user. To this aim, for example, a housing H of the hearing aid device 1 can be provided with a temperature sensor 7, for example a thermocouple, a temperature sensitive material, a temperature dependent resistor, an infra red (IR) radiation sensor, or a different sensor. The hearing aid device 301 of the FIG. 4 embodiment can also be configured to be used in a system a mentioned above, concerning the measuring of otoacoustic emissions OAC, but this is not necessary.

During use of the embodiment of FIG. 4, the hearing aid device 301 is being worn by the user. For example, the hearing aid device 301 can be positioned at least partly in an ear canal of the user. The hearing aid device 301 can detect at least one property of the user, for example a temperature of the user using the temperature sensor. Similar to the above method, for example, wherein the hearing aid device 301 can generate a message in case the detected property, such as temperature, reaches a predetermined threshold value of that property. In this way, the hearing aid device 301 can function as a hearing aid, but can also provide a means to monitor one or more properties such a physical properties of the user. For example, the hearing aid device 301 can be configured detect at least one property of the user when the device is in a hearing aid mode. Besides, the hearing aid device 301 can be configured to detect one or more properties of the user when the hearing aid device 301 is switched to a suitable second mode, for example a detection mode.

The hearing aid system and hearing aid device provided by the present invention can advantageously be used by small children, mental handicapped patients, or different users. In certain embodiments, such as shown in FIGS. 1-3, adjustments of the hearing aid device can be carried out in a simple and relatively inexpensive manner, preferably without having to rely on feedback provided by the user of the hearing aid device. For example, the hearing aid device itself can evoke the mentioned otoacoustic emissions of an inner ear of a patient. In an embodiment, the hearing aid device sends sounds into the ear canal EC, and the hearing aid device measures the otoacoustic signals OAE. The received signals OAE can depend on the hearing loss of the patient. The gain of the hearing aid device can be adapted, based in the received signals OAE.

In this way, traditional cumbersome measurement of a patient's hearing loss can be avoided. Besides, (slow) variations or deteriorations of a hearing loss can be followed in an adaptive way by the hearing aid system. Besides, embodiments of the hearing aid device can provide a monitoring device to monitor one or more properties of the carrier of the device, for example to monitor hearing loss, and/or to monitor a temperature of the user (such as in the embodiment of FIG. 4).

Although the illustrative embodiments of the present invention have been described in greater detail with reference to the accompanying drawings, it will be understood that the invention is not limited to those embodiments. Various changes or modifications may be effected by one skilled in the art without departing from the scope or the spirit of the invention as defined in the claims.

1. Method to adjust a hearing aid device, the method comprising:
generating one or more acoustic signals to induce otoacoustic emissions in an inner ear of a user of the device;
measuring the otoacoustic emissions; and
adjusting the hearing air device based on a result from the measurement of the otoacoustic emissions, wherein the inducing or measuring of the otoacoustic emissions is at least partly carried out by the hearing aid device.

2. Method according to claim 1, wherein the one or more acoustic signals are generated by a sound generator of the hearing aid device.

3. Method according to claim 1, wherein the one or more acoustic signals are generated in one of: an ear canal of the user, an outer ear of the user, and externally with respect to the outer ear of the user.

4. Method according to claim 1, wherein the adjusting of the hearing aid device includes adjusting one or more gain parameters of the hearing aid device.

5. Method according to claim 1, wherein the result of the measurement of the otoacoustic emissions is used to detect a hearing loss of the user of the hearing aid device, wherein at least one gain parameter of the hearing aid device is being adjusted to at least partly counteract the detected hearing loss.

6. Method according to claim 1, wherein the otoacoustic emissions are detected by a sound detector located in one of: the ear canal, in the outer ear, and externally with respect to the outer ear of the user of the hearing aid device.

7. Method according to claim 6, wherein the sound detector is part of the hearing aid device.

8. Method according to claim 7, wherein the position of the sound detector of the hearing aid device is adjusted from a first position, in which the sound detector can detect sounds originating from the environment of the user, to a second position, in which the sound detector is positioned to detect sound originating from the inner ear of the user.

9. Method according to claim 1, wherein a first sound detector is used to detect sounds originating from the environment of the user, wherein a second sound detector is used to detect sound originating from the inner ear of the user.

10. Method according to claim 1, wherein at least part of the hearing aid device is being worn by the user during one of: the measuring of the otoacoustic emissions and the adjusting of the hearing aid device.

11. Method according to claim 1, wherein a result of the measurement of the otoacoustic emissions is being stored and/or displayed.

12. Method according to claim 1, wherein the result of the measurement of the otoacoustic emissions is being compared to a hearing loss threshold value, wherein a message is being generated in case the result of the measurement of the otoacoustic emissions reaches the mentioned hearing loss threshold value.

13. Method according to claim 1, wherein the one or more acoustic signals include one of: short acoustic clicks, acoustic pulses and tone-bursts to induce transient otoacoustic emissions.

14. Method according to claim 1, wherein the one or more acoustic signals include at least two simultaneous tones of different frequencies to induce distortion product otoacoustic emissions.

15. Method according to claim 1, wherein the one or more acoustic signals include at least one sustained acoustic signal of a predetermined frequency to induce sustained-frequency otoacoustic emissions.

16. Method according to claim 1, wherein the hearing aid device detects at least one property of the user.

17. (canceled)

18. A storage medium including computer code configured to carry out a method comprising:
generating one or more acoustic signals to induce otoacoustic emissions in an inner ear of a user of a hearing aid device;
measuring the otoacoustic emissions; and
adjusting the hearing air device based on a result from the measurement of the otoacoustic emissions, wherein the inducing and/or or measuring of the otoacoustic emissions is at least partly carried out by the hearing aid device.

19. A hearing aid system, comprising a hearing aid device configured to be worn by a user, wherein the hearing aid device is configured to carry out measurements of otoacoustic emissions which emanate from at least one inner ear of the user during use.

20. System according to claim 19, further comprising at least one acoustic signal generator to generate one or more acoustic signals to induce otoacoustic emissions in the inner ear of a user.

21-42. (canceled)

43. The method according to claim 1, further comprising generating a message to the user to consult a doctor or to remove an obstruction in the ear canal.
